(19) United States
(12) Patent Application Publication
(10) Pub. No.: US 2014/0257956 A1
(43) Pub. Date: Sep. 11, 2014

(54) COUPON CODE REDEMPTION

(71) Applicant: CABLE TELEVISION LABORATORIES, INC., Louisville, CO (US)

(72) Inventor: Seetharama Durbha, Louisville, CO (US)

(73) Assignee: Cable Television Laboratories, Inc., Louisville, CO (US)

(21) Appl. No.: 13/855,669

(22) Filed: Apr. 2, 2013

Related U.S. Application Data
(60) Provisional application No. 61/773,744, filed on Mar. 6, 2013.

(51) Int. Cl. G06Q 30/02

(52) U.S. Cl. CPC G06Q 30/0225
USPC 705/14.23; 705/14.26

(57) ABSTRACT

Coupon code redemption and/or administration is contemplated. The coupon code administration may be performed by temporarily using specific codes in place of coupon codes. The specific code may be beneficial in restricting access to the coupon codes and/or swaying consumers to redeem coupon codes through certain service provider infrastructures. The specific code may be provided to a website when purchasing a product and replaced prior to purchase confirmation with the actual coupon code required for redemption.

### CROSS-REFERENCE TO RELATED APPLICATIONS

This application claims the benefit of U.S. provisional Application No. 61/773,744 filed Mar. 6, 2013, the disclosure of which is incorporated in its entirety by reference herein.

### TECHNICAL FIELD

The present invention relates to coupon code redemption, such as but not necessarily limited to coupon code redemption performed through a website when purchasing a product.

### BACKGROUND

Consumers of electronically delivered services may rely upon multiple content sources and/or multiple devices to facilitate access to desired services. This access ubiquity may empower consumers to subjectively choose the content sources and/or accessing devices relied upon to access to the desired services. The consumer's personal preferences or individual habits may become a driving factor when decisions are as to which content sources and/or devices will be utilized when consuming certain services. The consumer's personal preferences may potentially be more relevant than technological limitations or other operational constraints that may have at one time required the consumer to utilize particular content sources and or devices when consuming certain services. The service providers or other entities economically tied to the content sources and/or devices facilitating consumption of the services may face challenges in distinguishing themselves from their competitors.

One non-limiting aspect of the present invention contemplates a need to enable service providers or other entities economically tied to consumer decisions with an ability to sway consumers toward their content sources and/or devices.

### BRIEF DESCRIPTION OF THE DRAWINGS

FIG. 1 illustrates a system for coupon code redemption in accordance with one non-limiting aspect of the present invention.

FIG. 2 illustrates a messaging diagram for administering a coupon code in accordance with one non-limiting aspect of the present invention.

FIG. 3 illustrates an accounting information table or database the MSO may maintain to facilitate associating devices with subscriber accounts kept for subscribers/consumers authorized to access services associated with the MSO.

FIG. 4 illustrates a code entries table or database the MSO may maintain to facilitate associating coupon codes with the account information included within the account information table.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

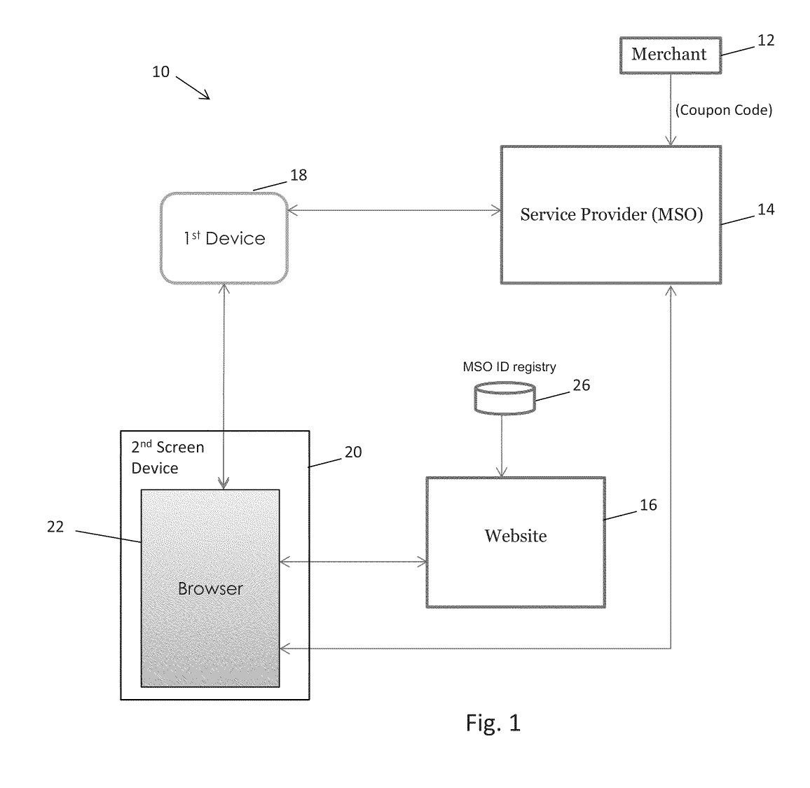

FIG. 1 illustrates a system 10 for coupon code redemption in accordance with one non-limiting aspect of the present invention. The system 10 may be configured to facilitate administering a coupon code issued from a merchant 12 in order to sway consumers to rely upon or otherwise choose services associated with a service provider 14. The coupon code may be redeemed through a website 16 or other point of sale (POS) device when purchasing a product provided by or otherwise associated with the merchant 12, such as to obtain a lower price, free shipping, etc. The coupon code may be administered in such as a way that a consumer must avail themselves of the services associated with the service provider 14 in order to redeem the coupon code. This type of coupon code qualification may be beneficial in swaying consumers to rely upon the services, systems, capabilities, etc. of the service provider 14 instead of those provided by other services providers if those other service providers are unable to administer the coupon code and/or if an agreement between the merchant 12 and the service provider 14 prevents those other service providers from offering the same coupon code.

The service provider 14 may be a cable, satellite or broadcast service provider, an internet service provider (ISP), a cellular or mobile phone service provider, a voice of Internet Protocol (VoIP) service provider, a multiple system operator (MSO) or other type of service provider having an economic interest or reward in providing services over a corresponding infrastructure of content sources, access points, devices and the like. The service provider 14 is described for exemplary non-limiting purpose as being a video or television service provider having a head-end, server or other content source configure to source video to a plurality of devices. A first device 18 is shown to facilitate access to the service provider's services, such through signaling carried over a wired or wireless network and/or communication medium. The first device 18 may be a set top box (STB), a media terminal adapter (MTA), a personal Digital assistant (PDA), a computer, a tablet, a mobile phone, a smart phone, a television or other device having capabilities sufficient to facilitate interfacing services with a user or subscriber of the service provider. While a single, first device 18 is shown, the system may be configured to facilitate similar services to multiple devices and or subscriber/consumers.

A second device 20 is shown to interact with the first device. The second device may be a similar device and or a different type of device. The second device 20 may be configured as a second screen device having an application configured to complement, enhance or otherwise supplement services provided through the first device. In the event the first device 18 is being used to descramble or otherwise process video provided from the service provider 14 for output to a television or other output device, the second device 20 may be a tablet, a mobile phone or other device configured to provide a second screen application that augments the user experience relative to the content or other information showing or provided through the first device, such as in the manner described in U.S. patent application Ser. Nos. 12/827,147, 13/534,238, and 13/755,254, the disclosures of which are hereby incorporated by reference in their entireties. The first device 18 is shown to communicate with the second device 20 over a wired or wireless communication medium for exemplary non-limiting purposes as other communications, such as those described in the above referenced patent applications, may be used to facilitate communications with the first device and/or the service provider.

The second device 20 is shown to include a browser 22 or other application/element having capabilities sufficient to access the website 16 or POS device through which the coupon code may be redeemed. The use of the second device 20 to facilitate redemption of the coupon code is described for exemplary non-limiting purposes as the present invention fully contemplates its use and application in environments where the second device 20 may be included as part of the first device 18 and/or the first device 18 may be configured to facilitate redemption of the coupon code without use of the second device 20. The second device 20 is described as one non-limiting aspect the present invention particularly contemplates facilitating redemption of the coupon code while the second device 20 is being used to augment or otherwise enhance services accessed through the first device 18. Of course, the present invention is not necessary so limited and fully contemplates facilitating coupon code redemption without use of the second device 20 and/or while the second device 20 is not being used to augment services of the first device 18. The first device 18 and/or the second device 20 may be or may include a computer program product having non-transitory instructions stored thereon, which may be operable with a processor or other logically executing element, to facilitate redeeming the coupon code and/or performing other operations associated with redeeming the coupon code in the manner contemplated by the present invention.

A registry 26 is shown to be in communication with the website. The registry 26 may include a database for storing information associated with facilitating redemption of the coupon code. The registry 26 may include a certificate, a public key or other information used to verify or test the integrity of data provided when attempting to redeem the coupon code through the website 16. The registry 26 is shown to be a standalone feature for exemplary non-limiting purposes as the registry may be included with or otherwise associated with one or more of the other devices illustrated as part of the system 10. One non-limiting aspect of the present invention contemplates facilitating redemption of the coupon code without exposing the coupon code to the redeeming device, i.e., the second device 20, such as by providing a specific code or variation of the coupon code to the second device 20. The specific code may then be input to the website 16 or otherwise provided to the website 16 when attempting to purchase a product. Information associated with the registry 26 may then be used in cooperation with the specific code to facilitate us of the coupon code. The specific code may be generated at an individual or account-level in order to restrict its usage to authorized consumers, e.g., consumers that avail themselves of the services associated with the service provider 14. The information included within the registry 26 may be beneficial in facilitating this type of consumer-specific coupon code redemption.

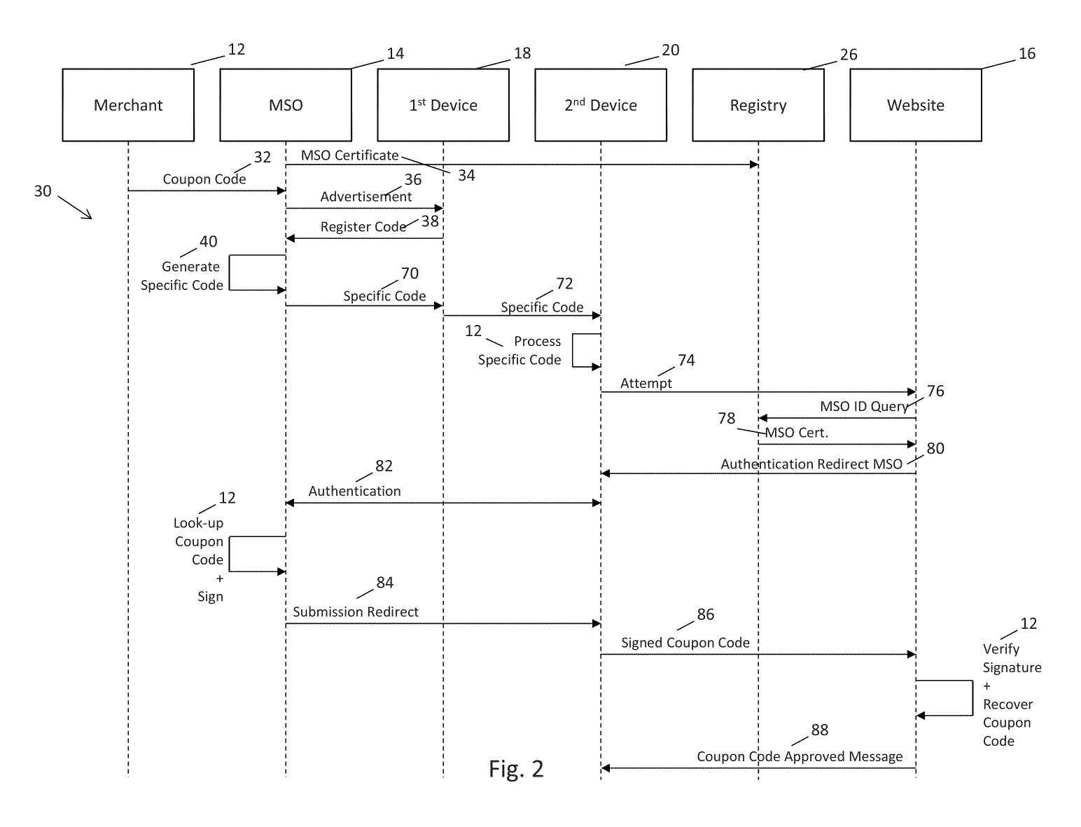

FIG. 2 illustrates a messaging diagram 30 for administering a coupon code in accordance with one non-limiting aspect of the present invention. The messaging diagram 30 describes possible messaging and communication associated with administering the coupon code within the context of the system 10 illustrated in FIG. 1. The method for administering coupon codes is not necessarily limited to the system 10 illustrated in FIG. 1 as the present invention fully contemplates administering coupon codes using more or less of the components illustrated in FIG. 1. The messaging diagram 30 of FIG. 2 presumes use of the website 26 and the first and second devices 18, 20 to demonstrate one capability of the present invention to facilitate coupon code redemption through a website using a second screen device configured to augment services provided through a primary or first device. Similar coupon code administration may be achieved through other POS interfaces and without the necessity of interaction between a first device 18 and the second device 20, e.g., the messaging associated with the first device 18 and the second device 20 may be performed relative to a single device.

An MSO certificate message 34 may be communicated from the MSO 14 to the registry 26. The MSO certificate message 34 may convey a certificate, public key or other security measure to the registry for subsequent use in verifying or otherwise authenticating information utilized to facilitate coupon code redemption. One non-limiting aspect of the present invention contemplates swaying consumers to utilize services associated with particular service provider/MSOs 14. Multiple MSOs may provide unique certificates to the registry 26 to ensure security of the coupon codes designated for use within their corresponding infrastructures. A single merchant 12 is described for exemplary non-limited purposes but similar processes may be performed to facilitate securing and redeeming coupon codes associated with multiple merchants, i.e., the registry 26 may be configured to facilitate storing information for multiple merchants and/or MSOs 14. The certificate provided within the MSO certificate message 34 may include an MSO identifier or other parameters sufficient to facilitate relating the corresponding certificate to a corresponding one of the MSOs 14, such as but not necessarily limited to an X.509 certificate. Optionally, in the event a single MSO desires enhanced security or different levels of security, multiple certificates may be provided to the registry with corresponding identifiers.

A coupon code message 32 may be communicated from the merchant to the MSO 14. The merchant 12 may provide the same coupon code to multiple MSOs 14. The illustrated MSO 14 may generate an advertisement message 36, such as Enhanced TV Binary Interchange Format (EBIF) message or a Society of Cable Television Engineers (SCTE) 130 message. The advertising message 36 may be sufficient to instruct or otherwise prompt the first device 18 to provide an advertisement or other offer to an associate consumer, such as by displaying a pop-up advertisement during video playback. The advertisement may be associated with the coupon code, such as by providing a numerical representation of the coupon code and/or a button or other interface that the consumer may engage to indicate a desire to purchase a corresponding product and/or to download that advertise coupon code. A register coupon code message 38 may be communicated from the first device 18 to the MSO 14 in response to determining an event indicating a consumer requests to receive the coupon code for subsequent redemption or to otherwise avail themselves of an offer related to the coupon code. The MSO 14 or another suitable entity may perform a subscriber specific (SS) code process 40 to generate a specific code in response to receipt of the register coupon code message 38. The specific code may be a unique code or identifier sufficient to facilitate identifying the coupon code and/or the device prompting issuance of the register coupon code message 38.

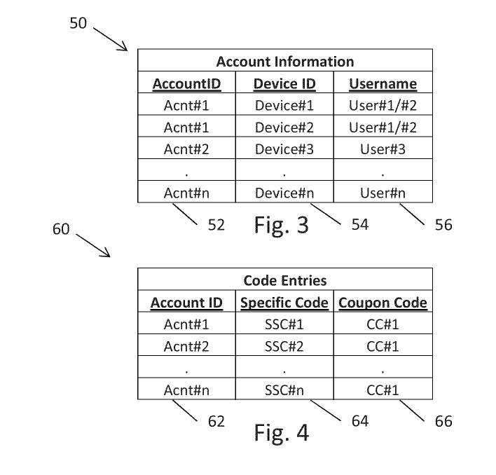

FIG. 3 illustrates an accounting information table or database 50 the MSO may maintain to facilitate associating devices with subscriber accounts kept for subscribers/consumers authorized to access services associated with the MSO. The account information table 50 may include an account ID column 52, a device ID column 54 and a username column 56. The device identifier included within the register coupon code message 38 may correspond with one of the device identifiers included within the device ID column 54. The device identifiers may correspond with addresses or other unique information assigned to the devices (if network address translation is used, multiple devices in a home or common account may be assigned the same device identifier). The device identifier may then be cross-referenced with one or more account identifiers included within the account ID column 52 and one or more user identifiers included within a username column 56. The account ID column 52, the device ID column 54 and the username column 56, may be populated with corresponding identifiers when service is activated in order to provide referencing between accounts and the devices and/or users assigned or authorized to access services associated with the corresponding account. As shown, multiple devices and users may be associated with the same account, e.g., Acnt #1 is shown to be associated with multiple devices (Device #1 & Device #2) and multiple users (User #1 & User #2). Optionally, multiple users and/or multiple devices may be associated with multiple accounts such that additional information may be needed in order to differentiate the particular account information.

FIG. 4 illustrates a code entries table or database 60 the MSO may maintain to facilitate associating coupon codes with the account information included within the account information table. The code entries table may include an account ID column 62, a specific code column 64 and a coupon code column 66. The specific codes tabulated within the specific code column 64 may be generated upon following receipt of register coupon code messages 38 received from various devices within the domain of the MSO 14, although they may be generated before. The specific codes assigned to each account identifier may be unique relative to the other account identifiers such that each account is assigned a unique specific code for the same coupon code. The uniqueness may be achieved by concatenating, hashing or otherwise processing the generic or commonly used coupon code with the device identifier of the requesting device 18 as the device identifier may be unique to the device and/or the individual accounts. In the event multiple devices and/or user associated with the same account request the same coupon code, the same specific code may be generated as a function of a first requesting one of the devices and/or separately unique specific codes may be generated to assign particular specific codes to each of the requesting devices and/or users (e.g., multiple users may use the same device to request the same coupon code such that additional information besides the requesting device may be needed to generate the unique specific code in this case).

The two tables 50, 60 are shown to be separate for exemplary non-limiting purposes as the information contained therein, and optionally additional information, may otherwise be related to facilitate generating unique specific codes on a per account and/or at a per user basis. The specific codes may be subsequently used in place of the coupon codes when attempting to redeem the corresponding offer, optionally without exposing the coupon code to the first device 18, the second device 20 and/or user. The use of the specific codes may provide a mechanism for tying generic coupon codes to specific accounts, devices, and/or user so that the corresponding account, device and/or user can be identified and/or verified when a subsequent redemption is attempted, e.g., upon input of a specific code in the website. Tying the coupon codes to the specific codes, and thereby particular entities, may be beneficial in swaying consumers to use MSO provided services to receive the offers associated with coupon codes and/or when attempting to redeem the coupon codes. The specific codes may optionally be unredeemable with devices disconnected from the MSO infrastructure and/or services whereas the coupon codes may be redeemable without such a restriction (preventing exposure of the coupon codes may be beneficial in this scenario). Signaling checks, addressing information and/or other operations may be performed to determine whether a redeeming device is sufficiently connected to a particular MSO infrastructure.

Returning to FIG. 2, a specific code message 70 may be transmitted from the MSO 14 to the first device 18 in response to receipt of the register coupon code message 38. The specific code message 70 may identify the specific code generated and/or recovered from the above identified databases for an account associated with the first device 18, or in the event the user interfacing through the first device 18 is not authorized within the account of the first device 18, a log-in or zero sign-on (ZSO) may be performed to identify the relevant specific code. As noted, the specific codes may be used to restrict redemption of the corresponding coupon codes by tying the specific codes to individuals, accounts, devices, etc. The administration described with respect to FIG. 2 illustrates a scenario where the specific code is tied to the account of first device 18, as opposed to the user of the first device 18, for exemplary non-limiting purposes as the specific code may similarly be tied to the user of the first device 18 or otherwise tied to certain events in order to limit redemption in a manner that sways consumers to particular MSOs or other service providers. The illustration of FIG. 2 also presumes the services associated with the first device 18 are being augmented with a second screen application of the second device 20 or the second device 20 is otherwise being used in cooperation with the first device 18, such as being used as a remote control. The present invention is not necessarily so limited and fully contemplates the operations described below with respect to the second device 20 being performed by the first device 18 or some common device.

The first device 18 may recover the specific code from the specific code message 70 for transmission to the second device 20 in a second device message 72. The first device 18 may identify the second device 20 from a plurality of devices authorized to support or augment operations of the first device 18, through presence detection (e.g., in the manner described in U.S. patent application Ser. No. 13/792,089, disclosure of which is hereby incorporated by reference in its entirety), user identification of the second device 20 and/or other suitable operations. The second device 20 may process the second device message 72 to recover the included specific code. The first device 18 associated with the specific code or other information used to tie the specific code to particular accounts and/or users may be identified within the second device message 72 for use by the second device 20 in identifying opportunities when the corresponding specific code may be utilized. One non-limiting aspect the present invention contemplates the second device 20 determining an opportunity to utilize the specific code when the included browser is directed towards the website 16. Information included with download of the website 16 may include identifying characteristics that the second device 20 can match with responding information included within the second device message 72 to determine the appropriate specific code. This information may be tried from information included within the coupon code but in a manner that prevents exposure to coupon code to the second device.

When accessing a suitable website 16, the second device 20 may automatically display a pop-up or other message indicating availability of the specific code for use with that website. Optionally, user the second device may be required to determine suitability of the specific code personally rather than being notified by the second device 20 and/or the browser 22. An attempt message 74 or other event trigger may be generated when the second device attempts to redeem the specific code through the corresponding website 16. The attempt message 74 may correspond with the second device 20 engaging a purchase button or otherwise communicating a desire to purchase a product through the website 16 associated with the specific code. The attempt message 74 may also correspond with the second device delivering the specific code to the website 16, such as in automatic operation or redirect performed as a function of the specific code processing and/or according to user input to the website 16. In response to receiving the specific code or otherwise determining an attempt to redeem the specific code, the website 16 may issue an ID query message 76 to the registry. The ID query message 76 may be used to receive a certificate message 78 for a service provider associated tied to the specific code, which is illustrated as being the MSO that previously provided a certificate to the registry 26. The registry 26 may retrieve the previously provide certificate for transmission within a certificate message and use by the website 16. Optionally, the certificate provided within the certificate message 34 from the MSO 14 may be delivered directly to the website 16 instead of the registry 26, thereby eliminating the need for the website to contact the registry.

The ID query 76 generated by the website 16 may be based on identify information included with the specific code and/or otherwise derived from the attempt 74 to redeem the specific code. The identifying information may be used to specify the MSO certificate to be returned the website 16. The identifying information may also be used to formulate an authentication redirect message 80 for transmission to the second device. The authentication redirect message 80 may be used to direct the second device 20 to perform an authentication 82 with the MSO 14 associated with the specific code, i.e., to perform an operation or otherwise confirm authenticity of the second device to utilize the specific code. The authentication redirect message 80 may direct the second device 20 to perform any type or number of operations in order to authenticate its use of the specific code, and thereby, the underlying coupon code. Within the context exemplary description of the second device 20 providing the browser 22 or other second screen application to facilitate an attempt to redeem the specific code through the website 16, the authentication redirect message 80 may be configured to automatically redirect the browser 22 to the MSO 15, such as without requiring user interaction and/or automatically opening a new webpage. The redirect message 80 may include a universal resource locator (URL) or other addressing information sufficient to direct the second device 20 to an authentication interface supported by the MSO 14 or a trusted third-party associate with the MSO.

The second device 20 may transmit an authentication request message to the MSO 14 as part of the authentication 82 according to information included within the authentication redirect message 80 received from the website 16. The MSO 14 may perform an authentication of the second device 20 and/or user the second device 20 to determine whether the user and/or the second device 20 are within the domain of the MSO 14 or otherwise sufficient authorized to redeem the specific code. The authentication process may include the use inputting a username and password, delivery of a credential (e.g., through the ZSO described in U.S. patent application Ser. No. 13/173,630, the disclosure of which is hereby incorporated by reference in its entirety) or other suitable processes related to the manner in which the specific code is generated and tied to particular accounts, users and/or devices. The authentication process include the MSO 14 looking up account identifiers and/or proved users as a function of the specific code identified within the authentication request message, such as through use of the tables 50, 60 described above with respect to FIGS. 3 and 4. Once sufficient identifying information associated with the specific code is recovered, the MSO 14 may assess credentials provided from the second device 20 as part authentication, e.g., username password or ZSO credentials, to determine whether the attempted use of the specific code falls within the parameters agreed to with the corresponding merchant 12 to facilitate swaying consumers to route my upon the MSO infrastructure and/or services.

Following a successful authentication, the coupon code previously associated with the specific code identified within the authentication request message 82 may be retrieved and provided to the second device 20 for redemption through the website 16. Optionally, the MSO 14 may sign the coupon code according to the parameters specified within the MSO certificate transmitted to the registry 16 in order to facilitate securing transmission of the coupon code and/or to prevent exposure of the coupon code to the second device 20. A submission redirect message 84 may be transmitted from the MSO 14 with the coupon code to direct the browser 22 to automatically input the coupon code to the website 16 using a signed coupon code message 86. In the event the coupon code was not signed prior to inclusion within the submission redirect message 84, the browser 22 may automatically replace an input field of the website previously populated with the specific code with the coupon code to facilitate redemption through the website 16. In the event the coupon code was signed prior to inclusion within the submission redirect message 84, the website 16 may perform signature verification prior to permitting redemption of the coupon code. The signature verification may include decrypting the signed coupon code with the MSO certificate of retrieve from the registry 16, such as by decrypting the signed coupon code with a public key associated with the MSO identified within the MSO certificate.

In the event the coupon code is accepted, a coupon code approved message 88 may be transmitted from the website to the second device to confirm redemption. The coupon code approved message may, like the other messages provided to the second device 20 and/or the browser 22, be formatted according to HyperText Transfer Protocol (HTTP), to facilitate interaction with the browser, and optional display or interfacing with the corresponding user. Even the coupon code is denied, the coupon code approved message may instead provide the second device with instructions as to a means for obtaining use of the coupon code, such as by subscribing to services associate with the MSO 14 and/or attempting to utilize the specific code in another location associated with the MSO 14 or otherwise authorized for use with the specific code. As described above, one non-limiting aspect of the present invention contemplates use of a specific code in place of a coupon code, at least while the specific code is being transmitted between devices prior to final redemption, so as to secure the coupon code and/or sway consumers to utilize particular services. Once a final attempt is made to redeem the specific code, the original coupon code issued by the merchant may be retrieved and used through the POS. The ability to utilize the original coupon code when finally purchasing the product may be beneficial in allowing the merchant to issue a single coupon code to multiple MSOs and/or to enable websites to authenticate a coupon code without having to become aware of the individual specific codes and/or having to keep track of the specific codes issued by particular MSOs, especially since MSOs may generate the specific codes differently.

As supported above, one non-limiting aspect of the present invention contemplates an era of multiple content sources where it may be beneficial to utilize incentives that are specific to certain providers in order to motivate consumers to them. This may include enabling operators to provide ‘deals’ only to their subscribers. Such deals/offers will spread word-of-mouth, and others may choose to subscribe to cable in order to get or not miss-out on those offers/deals. This disclosure provides one such way where a coupon code may be provided to the subscriber, particularly while they were watching a relevant program or commercial, using their second screen application. When the user uses the coupon on a merchant site, the merchant site checks with the MSO to see if the user is indeed a subscriber. The technique presented allows flexibility for the MSO to implement the coupon validation logic, and relies on open and oft-used techniques for the merchant to use this solution.

One non-limiting aspect of the present invention contemplates administering a coupon code created by a merchant. The merchant shares the coupon code with the MSOs. The details of the offer are not shared, as the MSO has no use for the details. The MSO feeds that coupon code into the EBIF stream of the associated program/commercial. The coupon code is received by the STB at user's home, which it then transmits to the second screen application (through means not discussed here, but it is assumed that the STB and the second-screen application have a pre-established connectivity). [Also, the term STB is used to refer to any kind of device that can read the EBIF data from a video stream.] Optionally, the coupon code itself is not transmitted to the second screen app. A second code (referred to Subscriber specific [SS] code) is generated at the MSO back-end. This is triggered by the STB making a web services call to the MSO back-end. MSO back-end will generate a subscriber-specific (SS) code for the combination of actual coupon code and the subscriber ID. The MSO ID is prefixed to the SS code, to enable the merchant to identify which MSO(or outlet) this is coming from. The MSO ID is either a publicly available ID or mutually worked out between the MSO and the specific merchant. That SS code is then sent to the STB, which relays it to the second screen application, or displays on the screen.

The subscriber then enters the SS code into the merchant's web site (to be applied to a purchase). Merchant site realizes that before the offer can be given to the subscriber, the code needs to be validated. It identifies the MSO this code is coming from using the ID present in the SS code. Details of each MSO (as identified by their ID) could be stored within each merchant, or maintained centrally in a registry (that is secure and trusted). Merchant web site then redirects the user (either in the main page or using a pop-up) to the MSO web site, along with the SS code entered. MSO uses any number of techniques (like IP address matching, subscriber authentication, etc.) to ensure that this SS code belongs to the subscriber attempting to use it. After successful verification, it generates a digital signature on the original coupon code (and timestamp to ensure freshness of the signature), and redirects the user back to the merchant web site with that signature. Merchant's web site verifies that signature is valid (and timestamp is fresh enough), retrieves the original coupon code from the message, and applies that coupon to the subscriber's purchase. If the offers/deals offered compare well with a provider bill, then this could be result in a significant commercial value. Customers will be the merchants as well as the subscribers. Merchants may be motivated to use this channel for coupons, as it potentially can result in the MSO sharing with the merchant some information about the specific subscriber that the merchants cannot get otherwise. For the MSOs, it could result in the ability to glean into utilization of the coupons delivered through cable (and more specific of the purchases made by subscriber).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of facilitating redemption of a coupon code, the coupon code being redeemable through a website when purchasing a product, the method comprising:
determining a coupon registration from a first device, the first device generating the coupon registration as a function of interaction related to an advertisement associated with the coupon code, the coupon registration being sufficient to identify the coupon code and a device identifier associated with the first device;
determining a specific code for the coupon registration as a function of the coupon code and the device identifier, the specific code being different from the coupon code; and
providing the specific code to the first device to facilitate subsequent redemption of the coupon code.

2. The method of claim 1 further comprising:
performing an authentication of the specific code following an attempt to utilize the specific code with the website to facilitate purchasing the; and
providing the coupon code for use with the website in place of the specific code associated with the attempt if the authentication is successful.

3. The method of claim 2 further comprising providing the coupon code for use through the website as a signed coupon code, thereby requiring the website to decrypt the signed coupon code in order to recover and redeem the coupon code.

4. The method of claim 3 further comprising providing a certificate sufficient for use with the website to facilitate decrypting the signed coupon code.

5. The method of claim 4 further comprising providing the certificate prior to determining the coupon registration and prior to providing the specific code.

6. The method of claim 4 further comprising providing the certificate to a registry, the website associating the certificate with a provider identifier, the registry requiring the website to identify the provider identifier in order to receive the certificate.

7. The method of claim 5 further comprising associating the provider identifier with the specific code, the website determining the provider identifier from the association with the specific code identified as part of the attempt.

8. The method of claim 2 further comprising performing the authentication after providing the specific code to the first device.

9. The method of claim 2 further comprising performing the authentication with a second device, the second device being configured to facilitate a second screen application, the second screen application being configured to augment user interaction with the first device.

10. The method of 9 further comprising providing the coupon code to the second device for subsequent use with the website in place of the specific code.

11. The method of claim 10 further comprising receiving the specific code from the second device and selecting the coupon code provided to the second device as a function thereof.

12. The method of claim 11 further comprising receiving a user identifier from the second device and selecting the coupon code provided to the second device according to a lookup process, the lookup process requiring the specific code and the user identifier in order to select the coupon code from a plurality of coupon codes.

13. The method of claim 1 further comprising generating the specific code to be non-redeemable through the website when purchasing the product.

14. The method of claim 1 further comprising providing the specific code to facilitate redemption of the coupon code without providing a merchant issuing the coupon code the specific code.

15. The method of claim 10 further comprising receiving the coupon code from the merchant prior to generating the specific code.

16. A method of facilitating redemption of a coupon code comprising:
generating a plurality of specific codes for the coupon code, each specific code being unique and associated with no more than one of a plurality of account identifiers, each account identifier being associated with at least one of a plurality of device identifiers and at least one of a plurality of users;
receiving a first coupon authentication request from a first device, the first coupon authentication request identifying a first specific code of the plurality of specific codes;
determining whether a first user associated with the first coupon authentication request is one of the plurality of users;
if the first user is not one of the plurality of users, denying the first coupon authentication request;
if the first user is one of the plurality of users, determining whether a first device identifier associated with the first coupon authentication request is one of the plurality of device identifiers;
if the first device identifier is not one of the plurality of device identifiers, denying the first coupon authentication request;
if the first device identifier is one of the plurality of device identifiers, determining whether the first device identifier and the first user are both associated with a first account identifier of the plurality of account identifiers;
if the first device identifier and the first user are not both associated with the first account identifier, denying the first coupon authentication request; and
if the first device identifier and the first user are both associated with the first account identifier, granting the first coupon authentication request, including providing the coupon code associated with the first specific code to the first device for subsequent redemption.

17. The method of claim 16 further comprising:
receiving a second coupon authentication request from a second device, the second coupon authentication request identifying a second specific code of the plurality of specific codes;
determining whether a second user associated with the coupon authentication request is one of the plurality of users;
if the second user is not one of the plurality of users, denying the second coupon authentication request;
if the second user is one of the plurality of users, determining whether a second device identifier associated with the second coupon authentication request is one of the plurality of device identifiers;
if the second device identifier is not one of the plurality of device identifiers, denying the second coupon authentication request;
if the second device identifier is one of the plurality of device identifiers, determining whether the second device identifier and the second user are both associated with a second account identifier of the plurality of account identifiers;
if the second device identifier and the second user are not both associated with the second account identifier, denying the second coupon authentication request; and
if the second device identifier and the second user are both associated with the second account identifier, granting the second coupon authentication request, including providing the coupon code associated with the second specific code to the second device for subsequent redemption, the coupon code provided to the second device being the same as the coupon code provided to the first device.

18. The method claim 17 further comprising further comprising generating the first specific code following receipt of a first coupon registration and generating the second specific code following receipt of a second coupon registration, the first coupon registration being received from a third device of the plurality of devices and the second coupon registration being received from a fourth device of the plurality of devices, the third device being associated with the first device identifier and the fourth device being associated with the second device identifier.

19. A computer program product having non-transitory instructions stored thereon sufficient to, when executed with a processor, facilitate redemption of a coupon code, the instructions being sufficient to facilitate:
generating a plurality of specific codes for the coupon code;
associating each specific code with one of a plurality of account identifiers;
determining an attempt by a user to redeem a first specific code of the plurality of specific codes;
if the user is not associated with the first specific code, denying delivery of the coupon code for use in the attempt; and
if the user is associated, permitting delivery of the coupon code for use in the attempt.

20. The computer program product of claim 19 further comprising instructions sufficient to facilitate:
identifying an account associated with the first specific code as a function of a device initially provided the first specific code;
determining the user to be associated with the first specific code if the user facilitates input of an identifier associated with the account; and
determining the user not to be associated with the first specific code fi the user fails to facilitate input of the identifier associated with the account.
